(19) United States
(12) Patent Application Publication
(10) Pub. No.: US 2009/0249111 A1
(43) Pub. Date: Oct. 1, 2009

(54) Raid Error Recovery Logic

(75) Inventors: Jose K. Manoj, Lilbum, GA (US); Atul Mukker, Suwanee, GA (US); Sreenivas Bagalkote, Suwanee, GA (US)

Correspondence Address: LNG/LSI JOINT CUSTOMER;C/O LUEDEKA, NEELY & GRAHAM, P.C., P.O. BOX 1871, KNOXVILLE, TN, 37901, US

(73) Assignee: LSI CORPORATION, Milpitas, CA (US)

(21) Appl. No.: 12/055,656

(22) Filed: Mar. 26, 2008

(51) Int. Cl. G06F 11/07

(52) U.S. Cl. 714/2; 714/42; 714/E11.026; 714/E11.023

(57) ABSTRACT

A method of reading desired data from drives in a RAID1 data storage system, by determining a starting address of the desired data, designating the starting address as a begin read address, designating one of the drives in the data storage system as the current drive, and iteratively repeating the following steps until all of the desired data has been copied to a buffer: (1) reading the desired data from the current drive starting at the begin read address and copying the desired data from the current drive into the buffer until an error is encountered, which error indicates corrupted data, (2) determining an error address of the error, (3) designating the error address as the begin read address, and (4) designating another of the drives in the data storage system as the current drive.

### FIELD

This invention relates to the field of computer programming. More particularly, this invention relates to improved error handling in computerized data storage systems.

### BACKGROUND

RAID data storage systems are so-called Redundant Arrays of Inexpensive Disks. Thus, RAID systems use two or more drives in a variety of different configurations to save data. In one implementation of a RAID1 system, the exact same data is written onto two or more drives. Thus, if the data on one of the drives is bad, either because of a software issue or a hardware issue, then chances are that the data on one of the other drives in the RAID system is good. Thus, the use of a RAID system, such as RAID1, can reduce the probability of data loss.

However, the general RAID1 specification allows for a broad array of methods for writing data to and reading data from the disks in the array. Because the data is written to and read from more than one disk, the potential exists for a dramatic increase in the amount of overhead resources that are required for the read and write operations.

What is needed, therefore, is a system that overcomes problems such as those described above, at least in part.

### SUMMARY

The above and other needs are met by a method of reading desired data from drives in a RAID1 data storage system, by determining a starting address of the desired data, designating the starting address as a begin read address, designating one of the drives in the data storage system as the current drive, and iteratively repeating the following steps until all of the desired data has been copied to a buffer: (1) reading the desired data from the current drive starting at the begin read address and copying the desired data from the current drive into the buffer until an error is encountered, which error indicates corrupted data, (2) determining an error address of the error, (3) designating the error address as the begin read address, and (4) designating another of the drives in the data storage system as the current drive.

In this manner, the desired data is read from a single drive until a read error is encountered, at which time the read operation is switched to another drive, from which the desired data is read until another read error is encountered. Thus, the desired data is read from the drives in the data storage system in a manner where very little switching back and forth between the drives is required, and thus the system operates very quickly and efficiently, with fewer overhead resources required, such as buffers and memory, than other RAID1 data storage systems.

In various embodiments according to this aspect of the invention, the corrupted data is caused by at least one of a software problem and a hardware problem. In some embodiments, any corrupted data on each of the drives in the data storage system is overwritten with recovery data, such as after all of the desired data has been copied to the buffer, or as soon as the recovery data has been copied to the buffer, or as soon as a subsequent error is encountered. In some embodiments any corrupted data on each of the drives in the data storage system is overwritten either with recovery data from another of the drives in the data storage system or with recovery data from the buffer. According to other aspects of the invention there is described a controller for reading the desired data, and a computer readable medium having programming instructions for reading the desired data.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a diagrammatic representation of a first step of read request on a RAID system according to an embodiment of the present invention.

FIG. 2 is a diagrammatic representation of a second step of read request on a RAID system according to an embodiment of the present invention.

FIG. 3 is a diagrammatic representation of a third step of read request on a RAID system according to an embodiment of the present invention.

FIG. 4 is a diagrammatic representation of a fourth step of read request on a RAID system according to an embodiment of the present invention.

FIG. 5 is a diagrammatic representation of a fifth step of read request on a RAID system according to an embodiment of the present invention.

FIG. 6 is a diagrammatic representation of a sixth step of read request on a RAID system according to an embodiment of the present invention.

FIG. 7 is a diagrammatic representation of a seventh step of read request on a RAID system according to an embodiment of the present invention.

FIG. 8 is a functional block diagram of a controller for a RAID system according to an embodiment of the present invention.

FIG. 9 is a flow chart of read request on a RAID system according to an embodiment of the present invention.

### DETAILED DESCRIPTION

The various embodiments of the present invention describe an improvised Raid1 IO read error recovery logic, which is very simple to implement and handles multiple recoverable or unrecoverable media errors in the same stripe. These read and write operations are generally referred to as IO operations herein, and the data is generally referred to as IO herein. The steps of the method result in a relatively low number of IO operations, and can handle multiple errors, including double media errors. The method uses a very small amount of resources for the recovery task.

Exemplary embodiments of the present invention are provided herein. The examples cover some of the basic aspects of the invention. However, it is appreciated that there are permutations of the steps of the method and other steps within the spirit of the invention that are also contemplated hereunder. Thus, the present embodiment is by way of example and not limitation.

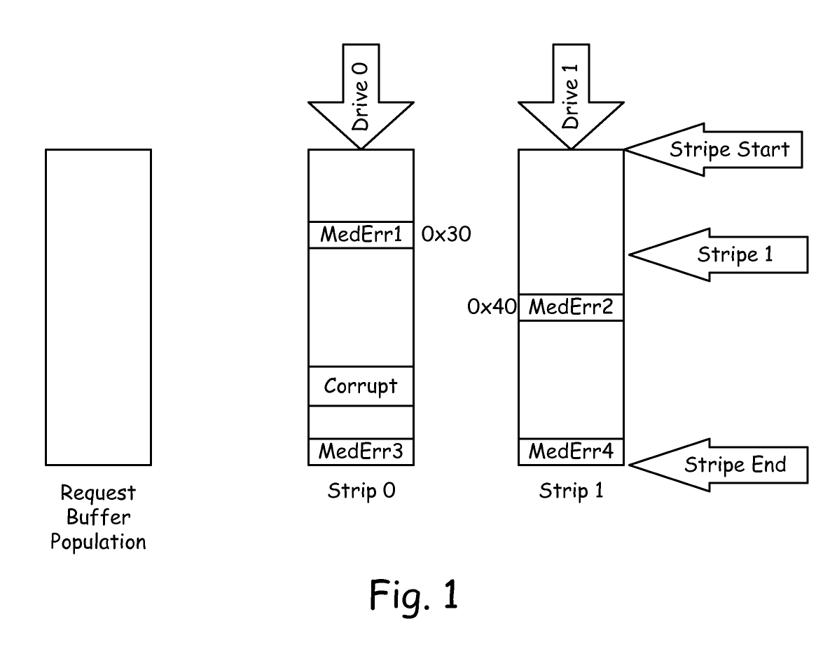

With reference now to FIG. 1, there is depicted a Raid1 stripe with multiple errors. Drive 0 contains media errors at offset 0x30 and in the last sector in the strip. These are considered to be software problems, because—although the data in these sectors is not correct—the data written to these sectors can be reliably read. There is an unrecoverable media error (labeled as “Corrupt”) in Drive0 in a range of sectors. The unrecoverable media error is considered a hardware problem, in that data written to these sectors cannot be reliably read. Drive 1 also contains media errors at both 0x40 and again in the last sector of the strip. Thus, in the present example there are two media errors that can be recovered with write backs (MedErr1 and MedErr2) and one double media error sector that cannot be recovered (MedErr3 and MedErr4). There is a non recoverable error (labeled as “Corrupt”) also present in Drive 0 that can be recovered from Drive 1, and thus a write back does not need to occur on that drive. The example is of a full stripe read on stripe 1. Because the system is a Raid1 logical drive, the read commands are serviced only by any one drive participating in the array, which in the present example is either Drive 0 or Drive 1. For present purposes, the read command is serviced by Drive 0 and the request buffer as depicted in FIG. 1.

### First Read Operation on System

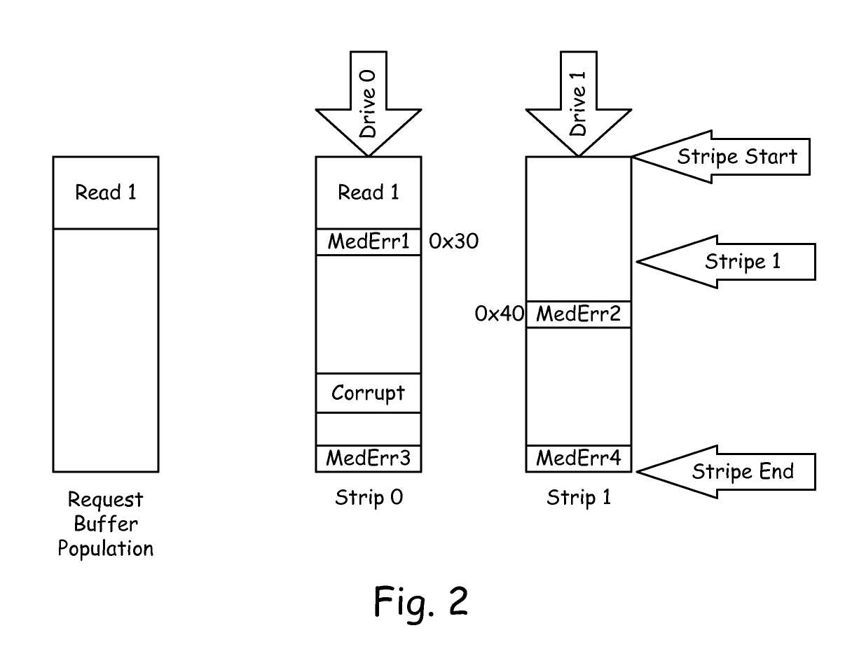

With reference now to FIG. 2, there is depicted the IO status after first stage of the read operation on Drive 0. The hardware abstraction layer in the RAID stack stops reading the data off of Drive 0 at the sector with the media error. At this point in time, then, the data buffer for the IO request is populated with the data from Drive 0 (Read 1) up until the sector with MedErr1. The system now enters a phase where it will recover the MedErr1.

### Recovery Read 2

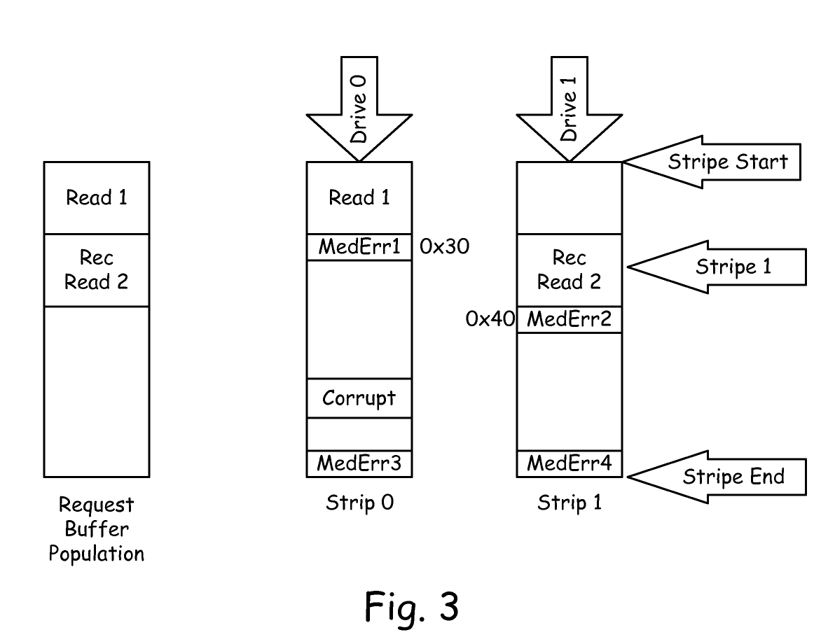

With reference now to FIG. 3, if an error occurs on the target drive (Drive 0), then the read operation shifts to the next drive (Drive 1), and an attempt is made to service the rest of the IO request from the peer drive (Drive 1), as indicated as Rec Read 2 (“Rec” indicating “Recovery”). The recovery method reads good data starting at 0x30 of Drive 1, and continues to try to read data off of Drive 1 until the end of the stripe is attained. The data buffer for this IO command is adjusted in such a way that the input buffer data is populated automatically. The original hardware abstraction layer command packet used for Read 1 on Drive 0 is used for this purpose. The SG list for the IO command is modified to adjust the data buffer properly, and the sector count and start sector are also adjusted for the command. However, because there is a MedErr2 in Drive 1, the IO command once again fails, this time at sector 0x40.

### Recovering MedErr1

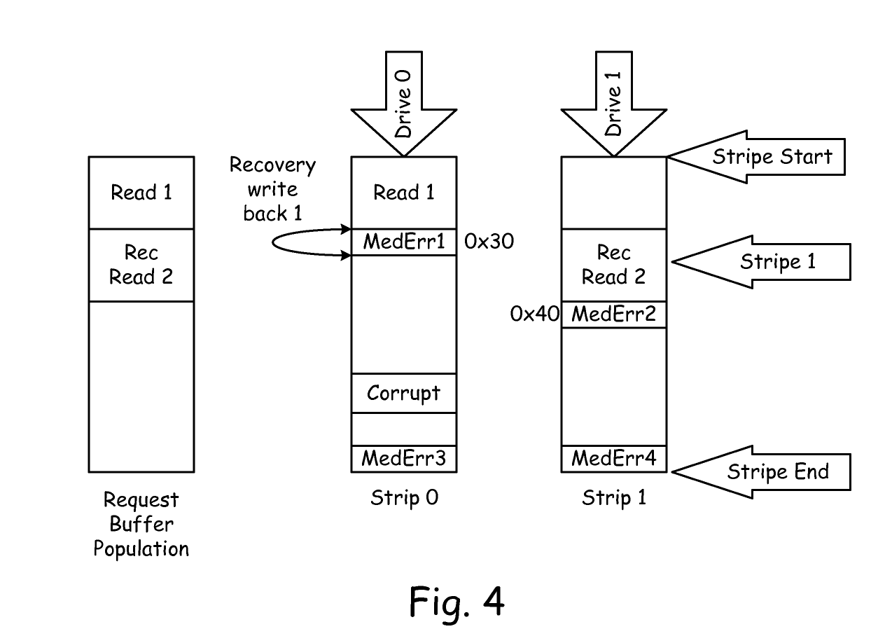

With reference now to FIG. 4, now that the data at MedErr1 is recovered in Rec Read 2 of the buffer, it can be used for performing a write back on the corresponding sector of Drive 0. A new IO command is created to write back the sector at the MedErr1 sector on Drive 0. After successful completion of this command, the packet is removed from the hardware abstraction layer.

### Recovery Read 3

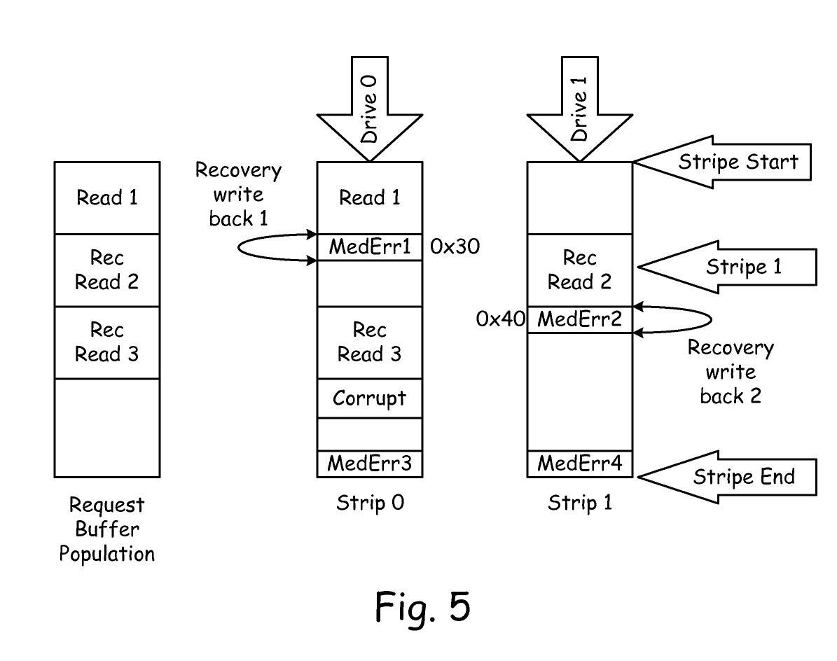

With reference now to FIG. 5, a new recovery read IO operations commences, Rec Read 3, to try to read the data from 0x40 of the “other” drive, which in this case is Drive 0, which IO operation will attempt to continue to read until the end of stripe on Drive 0. Once again, the data buffer for this IO command gets adjusted in such a way that the input buffer data is populated automatically. The original hardware abstraction layer command packet used for Rec Read 2 on Drive 1 is used for this purpose. As before, the SG list for this IO command is modified to adjust the data buffer properly, and the sector count and start sector also get adjusted for the IO command. However, Rec Read 3 is interrupted by the unrecoverable corruption on Drive 0, and so the IO command fails at the start of the non-recoverable error.

### Recovering MedErr2

Now that the data at MedErr2 is recovered in Rec Read 3 of the buffer, it can be used for performing a write back on the corresponding sector of Drive 1. A new IO command is created to write back the sector at the MedErr2 sector on Drive 1. After successful completion of this command, the packet is removed from the hardware abstraction layer.

### Recovering the Corruption Error

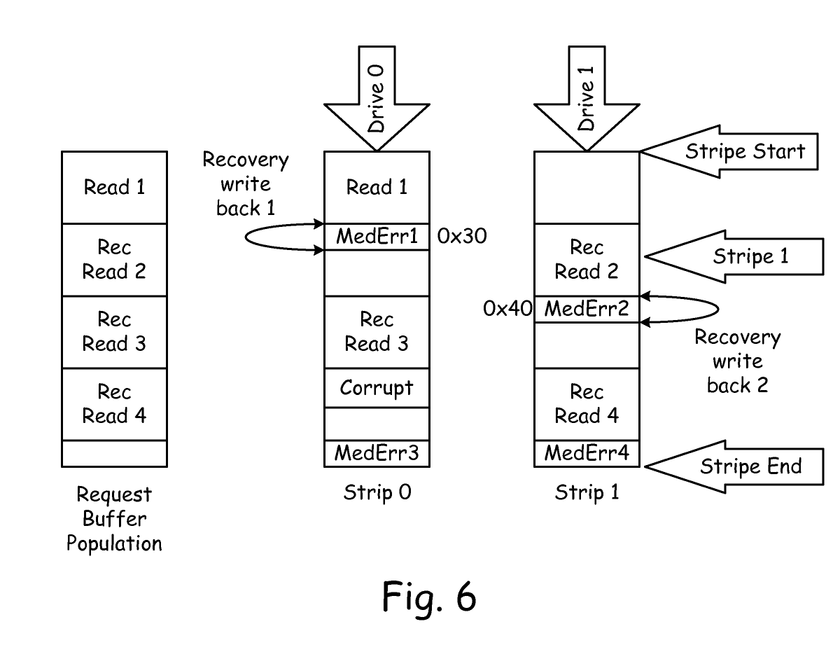

With reference now to FIG. 6, the method again switches to the other drive (Drive 1) in Rec Read 4, and attempts to read the data from the commensurate sector on Drive 1 up until the end of stripe. As before, the data buffer for the IO command is adjusted in such a way that the input buffer data is populated automatically. Again, the original hardware abstraction layer IO command packet that was used for Read 3 on Drive 0 is reused for this purpose. The SG list of the IO command is again modified to adjust the data buffer properly, and the sector count and start sector also get adjusted for the IO command. However, Rec Read 4 fails at MedErr4 on Drive 1.

### Recovering MedErr4

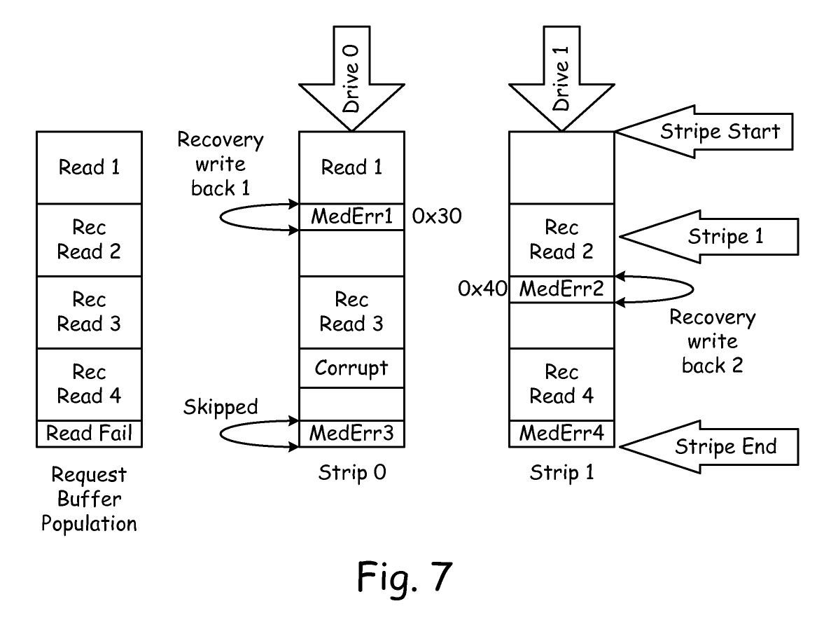

As depicted in FIG. 7, The RAID system tries to recover the data at MedErr4 from “the other drive,” which in this case is Drive 0, but that command also fails because MedErr3 on Drive 0 is disposed at the same location as MedErr4 on Drive 1. Thus, there is no good data on the RAID system for the data in those sectors. Further, a write back can't be performed on the Corrupt sector of Drive 0 using the good data from Drive 1 in Rec Read 4, because the corrupt sector of Drive 0 will not reliably hold data. Because of the unrecoverable double media error (MedErr3 and MedErr4), the buffer now contains a read failure, and the IO command finally terminally fails to the operating system with the proper error status.

### Block Diagram

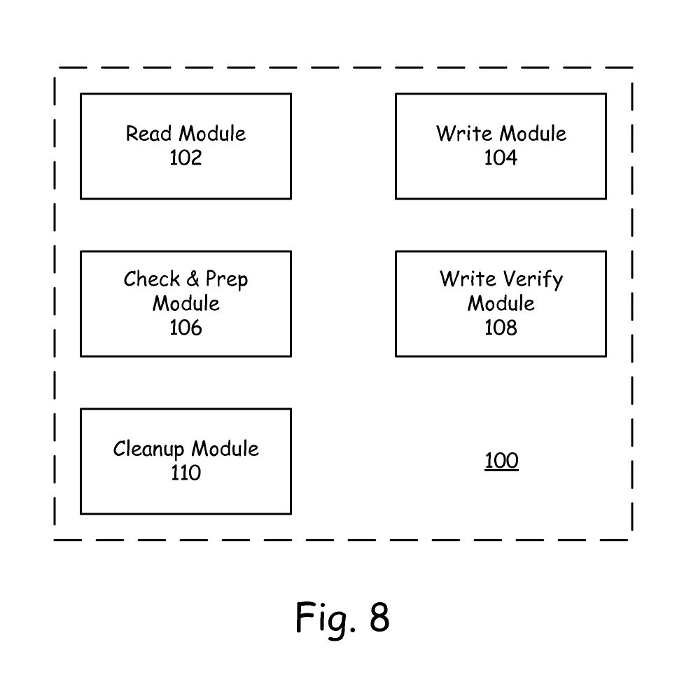

With reference now to FIG. 8, there is depicted a functional block diagram of the recovery system. The recovery system includes a read module for reading the various drives in the system, and a write module for writing to the drives in the system. The check and preparation module looks for errors in the data and otherwise checks and prepares the drives. The write verify module determines whether a write to a drive has been performed correctly. Finally, the cleanup module releases the resources that have been allocated to the recovery system, and returns control to the routine that called the recovery system.

### Flowchart

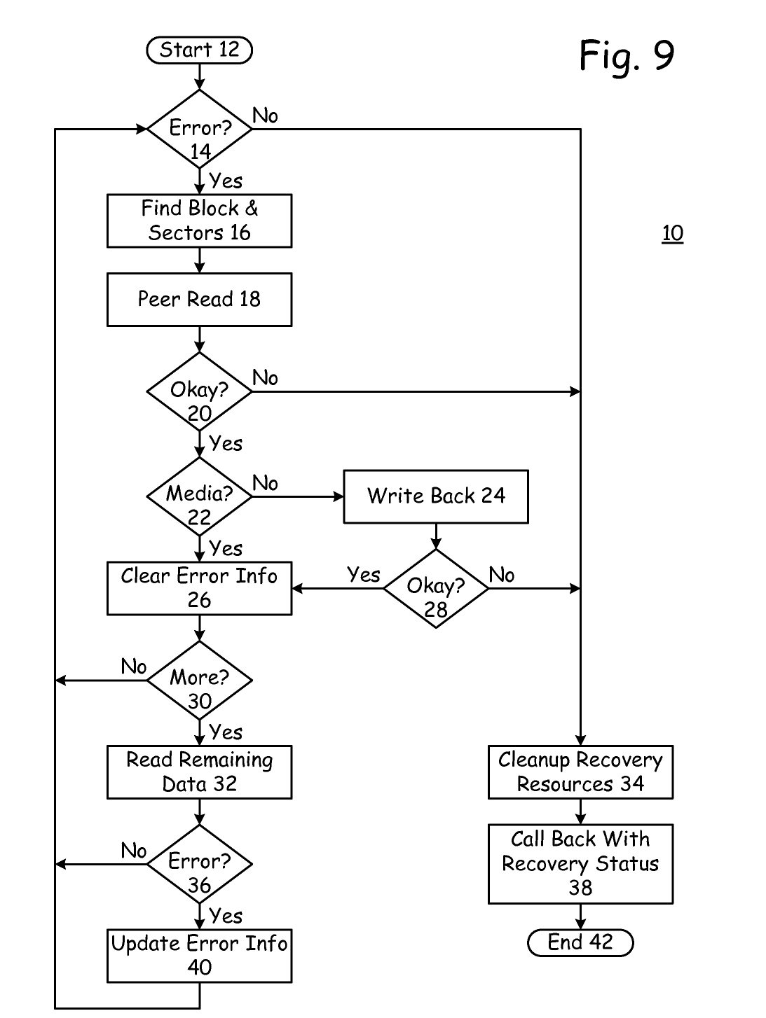

With reference now to FIG. 9, there is depicted a flowchart of a method 10 according to the present invention, which method starts with entry to the recovery system as given in block 12. In block 14, it is first determined whether there is an error to recover on the drive that is currently being read. If not, then control passes to block 34, where the recovery resources are released and otherwise cleaned up, and the recovery system 10 calls back the calling routine with the appropriate recovery statuses, as given in block 38, and the system 10 ends as given in block 42.

If, however, there is an error to recover on the current read drive, then control passes to block 16 where the physical block and the number of sectors to recover is determined. The block and sectors are then read from the peer drive, as given in block 18. If the recovery is not successful, as determined in block 20, or in other words, if the data that has an error on the target drive is also not available on the peer drive, then control again falls to block 34 and continues as described above.

However, if the recovery is successful, or in other words, if the data that has an error on the target drive is available on the peer drive, then control falls to block 22, where it is determined whether the error on the target drive was due to an unrecoverable media error. If not, then the recovered data can be put onto the target drive in a write back operation, as given in block 24. If the write back doesn't work properly, as determined in block 28, then control passes to block 34 and proceeds as described above.

If the write back is successful (as determined in decision block 28), or if the problem on the target drive was an unrecoverable media corruption error such that no write back could be attempted (as determined in decision block 22), then control passes to block 26 where the error information on the target drive is cleared.

Control then passes to decision block 30, where it is determined whether there is more data to be read from the peer drive. If there is not, then control passes back to decision block 14, to await another error. If there is more data to be read, then the remaining data is read as given in block 32. If an error with the recovery process is determined, as given in decision block 36, then the error information for the system 10 is updated, as given in block 40, and control passes back to block 14 to await a new read error. If there is no error in the recovery process 10, then control passes from block 36 directly to block 14.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of reading desired data from drives in a RAID1 data storage system, the method comprising the steps of:
determining a starting address of the desired data,
designating the starting address as a begin read address,
designating one of the drives in the data storage system as the current drive,
iteratively repeating until all of the desired data has been copied to a buffer,
reading the desired data from the current drive starting at the begin read address and copying the desired data from the current drive into the buffer until an error is encountered, which error indicates corrupted data,
determining an error address of the error,
designating the error address as the begin read address, and
designating another of the drives in the data storage system as the current drive.

2. The method of claim 1, wherein the corrupted data is caused by a software problem.

3. The method of claim 1, wherein the corrupted data is caused by a hardware problem.

4. The method of claim 1, further comprising the step of overwriting any corrupted data on each of the drives in the data storage system with recovery data, after all of the desired data has been copied to the buffer.

5. The method of claim 1, further comprising the step of overwriting any corrupted data on each of the drives in the data storage system with recovery data, as soon as the recovery data has been copied to the buffer.

6. The method of claim 1, further comprising the step of overwriting any corrupted data on each of the drives in the data storage system with recovery data, as soon as a subsequent error is encountered.

7. The method of claim 1, further comprising the step of overwriting any corrupted data on each of the drives in the data storage system with recovery data from another of the drives in the data storage system.

8. The method of claim 1, further comprising the step of overwriting any corrupted data on each of the drives in the data storage system with recovery data from the buffer.

9. A controller for performing a read operation of desired data from drives in a RAID1 data storage system, the controller comprising circuits for:
determining a starting address of the desired data,
designating the starting address as a begin read address,
designating one of the drives in the data storage system as the current drive,
iteratively repeating until all of the desired data has been copied to a buffer,
reading the desired data from the current drive starting at the begin read address and copying the desired data from the current drive into the buffer until an error is encountered,
determining an error address of the error,
designating the error address as the begin read address, and
designating another of the drives in the data storage system as the current drive.

10. The controller of claim 9, wherein the corrupted data is caused by a software problem.

11. The controller of claim 9, wherein the corrupted data is caused by a hardware problem.

12. The controller of claim 9, further comprising circuits for overwriting any corrupted data on each of the drives in the data storage system with recovery data, after all of the desired data has been copied to the buffer.

13. The controller of claim 9, further comprising circuits for overwriting any corrupted data on each of the drives in the data storage system with recovery data, as soon as the recovery data has been copied to the buffer.

14. The controller of claim 9, further comprising circuits for overwriting any corrupted data on each of the drives in the data storage system with recovery data, as soon as a subsequent error is encountered.

15. The controller of claim 9, further comprising circuits for overwriting any corrupted data on each of the drives in the data storage system with recovery data from another of the drives in the data storage system.

16. The controller of claim 9, further comprising circuits for overwriting any corrupted data on each of the drives in the data storage system with recovery data from the buffer.

17. A computer readable medium containing programming instructions operable to instruct a computer to read desired data from drives in a RAID1 data storage system, including programming instructions for:
determining a starting address of the desired data,
designating the starting address as a begin read address,
designating one of the drives in the data storage system as the current drive,
iteratively repeating until all of the desired data has been copied to a buffer,
reading the desired data from the current drive starting at the begin read address and copying the desired data from the current drive into the buffer until an error is encountered, which error indicates corrupted data,
determining an error address of the error,
designating the error address as the begin read address, and
designating another of the drives in the data storage system as the current drive.

18. The computer readable medium of claim 17, wherein the corrupted data is caused by a software problem.

19. The computer readable medium of claim 17, further comprising programming instructions for overwriting any corrupted data on each of the drives in the data storage system with recovery data, after all of the desired data has been copied to the buffer.

20. The computer readable medium of claim 17, further comprising programming instructions for overwriting any corrupted data on each of the drives in the data storage system with recovery data from the buffer.
